(19) United States
(12) Patent Application Publication
(10) Pub. No.: US 2026/0059603 A1
(43) Pub. Date: Feb. 26, 2026

(54) INTERFACE FOR MULTICAST AND BROADCAST SERVICE (MBS)

(71) Applicant: GOODLE LLC, Mountain View, CA (US)

(72) Inventors: Chien-Chun Huang Fu, Taipei (TW); Poying Chuang, Taipei (TW); Chih-Hsiang Wu, Taipei (TW)

(21) Appl. No.: 19/102,721

(22) PCT Filed: Aug. 4, 2023
(86) PCT No.: PCT/US2023/071672

§ 371 Date: Feb. 10, 2025

Related U.S. Application Data
(60) Provisional application No. 63/371,186, filed on Aug. 11, 2022.
(60) Provisional application No. 63/490,072, filed on Mar. 14, 2023.

(51) Int. Cl. H04W 76/22; H04L 12/18; H04W 76/12

(52) U.S. Cl. CPC H04W 76/22; H04L 12/1881; H04L 12/189; H04W 76/12

(57) ABSTRACT

This disclosure provides systems, methods, and apparatus, including computer programs encoded on computer-readable media, for an application processor (AP) 160 of a user equipment (EU) 150 to communicate with a modem 170 of the UE 150 to set, define and request status of a multicast and broadcast service (MBS) supported by an MBS protocol data unit (PDU) session. For example, the AP 160 can communicate with the modem 170 using one or more attention (AT) commands, such as an MBS session context (+CMSCONT) command 109 or an MBS session read dynamic parameters (+CMSRDP) command 124. The AP 160 can communicate with the modem 170 to modify an existing PDU session to support the MBS, or to establish a new PDU session for the MBS. An MBS PDU session that is requested by the UE 150 can be modified, accepted, or rejected by a network 180.

### TECHNICAL FIELD

This disclosure relates generally to wireless communication and to multicast and broadcast service (MBS).

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A wireless communication system can support a multicast and broadcast service (MBS). MBS is a point-to-multipoint service in which data is transmitted from a single source entity to multiple recipients, either to all users in a broadcast service area, or to users that have joined a particular multicast group. The corresponding types of MBS sessions are: broadcast MBS sessions and multicast MBS sessions. For both types of MBS sessions, MBS service data is transmitted over an associated protocol data unit (PDU) session between a user equipment (UE) and a data network (DN) of a wireless communication session. A PDU session defines an end-to-end user plane connectivity between the UE and the DN. The UE coordinates with a network entity (such as a base station or core network) to manage and configure PDU sessions associated with a service of the wireless communication system. The 3^{rd} generation partnership project (3GPP) standards body has described MBS in technical specifications such as technical specification (TS) 27.007, incorporated herein by reference. Traditional techniques for managing a PDU session are inadequate to support new features associated with a UE utilizing an MBS.

### SUMMARY

The systems, methods, and devices of this disclosure each have several innovative aspects, no single one of which is solely responsible for the desirable attributes disclosed herein.

This disclosure includes various examples of how a multicast and broadcast service (MBS) can be requested, modified, accepted, or rejected. In some implementations, a user equipment (UE) reconfigures an existing protocol data unit (PDU) session to support the MBS. In some implementations, the UE establishes a new PDU session for the MBS. A PDU session that supports an MBS may be referred to as an MBS PDU session.

In some implementations, a UE includes an application processor (AP) and a modem. The AP can communicate with the modem to reconfigure or establish an MBS PDU session. For example, the AP can communicate with the modem using one or more attention (AT) commands, such as an MBS session context (+CMSCONT) command or an MBS session read dynamic parameters (+CMSRDP) command. The modem of the UE can coordinate with a network entity to manage the MBS PDU session.

One innovative aspect of the subject matter described in this disclosure can be implemented method for managing an MBS PDU session by a UE. The method includes communicating one or more AT commands for the MBS PDU session from an AP of the UE to a modem of the UE.

Another innovative aspect of the subject matter described in this disclosure can be implemented as a managing an MBS PDU session by a UE. The method includes receiving, at a modem of the UE, one or more AT commands for the MBS PDU session from an AP of the UE.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example message flow for a UE to join an MBS over an existing PDU session where an interface between AP and modem includes one or more attention (AT) commands defining the MBS session operation and triggering the PDU session modification procedure, according to some implementations.

FIG. 2 shows an example message flow for a UE to join an MBS over an existing PDU session where an interface between AP and modem includes an AT command to join an MBS over an existing PDU session, according to some implementations.

FIG. 3 shows an example message flow for a UE to join an MBS by establishing a new PDU session associating with the MBS, according to some implementations.

FIG. 4 shows an example message flow in which a UE requests to join an MBS over an existing PDU session but the network rejects the MBS join request, according to some implementations.

FIG. 5 shows an example message flow in which a UE requests to join an MBS session over an existing PDU session but the network rejects the PDU session modification request, according to some implementations.

FIG. 6 shows an example message flow in which a UE requests to join an MBS session and establish a new PDU session associating with the MBS session but the network rejects the MBS join request, according to some implementations.

FIG. 7 shows an example message flow in which a UE requests to join an MBS session and establish a new PDU session associating with the MBS session but the network rejects the PDU session establishment request, according to some implementations.

FIG. 8 shows an example of AT command for setting or defining an MBS PDU session, according to some implementations.

FIG. 9 shows an example of an AT command for both setting or defining an MBS session context for the MBS PDU session and trigger a PDU session modification procedure, according to some implementations.

FIG. 10 shows an example of an AT command for querying the status of an active MBS PDU session, according to some implementations.

FIG. 11 shows an example of an AT command for querying the status of an active MBS PDU session, according to some implementations.

FIG. 12 shows an example implementation of a UE.

FIG. 13 shows an example implementation of a network.

Like reference numbers and designations in the various drawings indicate like elements.

### DETAILED DESCRIPTION

A multicast and broadcast service (MBS) is transmitted over an associated protocol data unit (PDU) session. A user equipment (UE) (which also may be referred to as a terminal equipment (TE)) can join or leave an MBS session of the MBS. In some implementations, the UE modifies an existing PDU session or establishes a new PDU session that supports an MBS. A PDU session that supports an MBS may be referred to as an MBS PDU session. A UE can join one or more MBS sessions via the MBS PDU session. In some implementations, commands between the application processor (AP) and the modem of the UE are used to define, modify, or establish an MBS PDU session. The AP of the UE can set or define an MBS session context for the MBS PDU session by providing an attention (AT) command to the modem of the UE. Furthermore, the AP can initiate a PDU session modification procedure or a PDU session establishment procedure for the MBS PDU session by communicating an AT command to the modem. The modem of the UE can coordinate with a network entity to manage the MBS PDU session.

If the MBS session is multicast, the Service Announcement (over the application layer) can include the data network name (DNN) and network slice selection assistance information (S-NSSAI) of the PDU session to indicate which PDU session should be associated with the MBS. The MBS service-related information (such as default public land mobile network identifier (PLMN ID), DNN and S-NSSAI) can also be pre-configured in the UE.

If there is an existing PDU session that the UE can use to send a join request for an MBS session, the UE sends a PDU Session Modification Request over that PDU session. If the UE has no appropriate PDU session established with the DNN and S-NSSAI for the MBS session, the UE joins the MBS session by sending PDU Session Establishment Request requesting establishment of an associated PDU session together with one or several MBS Session ID(s) and join request, as further described below.

Either the UE or the network can request to leave the MBS session. When the UE determines to leave the MBS session, it sends a PDU session Modification request to inform the core network (such as a network entity of a 5G core network (5GC)) regarding the leaving operation. When the network determines to remove the UE from the MBS session, a core network component (such as session management function (SMF)) initiates a PDU session modification procedure (i.e., sending PDU session Modification command) to inform the UE of the MBS session release.

An MBS session can be location dependent. For local multicast services, the MBS service area information is provided to the UE. The UE can have information about local multicast service including MBS service area via Service Announcement over application layer. If the UE determines it is in the MBS service area (based on the information about local multicast service such as obtained via Service Announcement), the UE sends the PDU session modification request (with MBS session ID) or the PDU session establishment request (with MBS session ID) to join the multicast group.

The Requested MBS container information element (IE) (shown in Table 1) is used for the UE to request to join or leave one or more MBS sessions in either PDU session establishment request message or PDU session modification request message.

TABLE 1

| | | | | | | | |
|---|---|---|---|---|---|---|---|
| 8 | 7 | 6 | 5 | 4 | 3 | 2 | 1 |

| Requested MBS container IEI | octet 1 |
|---|---|
| Length of Requested MBS container contents | octet 2 |
| | octet 3 |
| MBS session information 1 | octet 4 |
| | octet l |
| MBS session information 2 | octet l + 1* |
| | octet l |
| . . . | octet l + 1* |
| | octet m* |
| MBS session information p | octet m + 1* |
| | octet n* |

TABLE 2

| | | | | | | | |
|---|---|---|---|---|---|---|---|
| 8 | 7 | 6 | 5 | 4 | 3 | 2 | 1 |

| | | | | | | |
|---|---|---|---|---|---|---|
| 0 | 0 | 0 | 0 | MBS operation | Type of MBS | octet 4 |

| | |
|---|---|
| spare | session ID |

| MBS session ID | octet 5 |
|---|---|
| | octet l |

As shown in Table 2, the main parameters are: “Type of MBS session ID” and “MBS operation.” The “Type of MBS session ID” can be “Temporary Mobile Group Identity (TMGI),” “Source specific IP multicast address for IPV4” or “Source specific IP multicast address for IPV6.” The “MBS operation” can be “Join MBS session” or “Leave MBS session.”

As shown in Table 3, the Received MBS container information element is used by the network to indicate to the UE the information of the MBS sessions.

TABLE 3

| | | | | | | | |
|---|---|---|---|---|---|---|---|
| 8 | 7 | 6 | 5 | 4 | 3 | 2 | 1 |

| Received MBS container IEI | octet 1 |
|---|---|
| Length of Received MBS container contents | octet 2 |
| | octet 3 |
| Received MBS information 1 | octet 4 |
| | octet l |
| Received MBS information 2 | octet l + 1* |
| | octet l* |
| . . . | octet l + 1* |
| | octet m* |
| Received MBS information p | octet m + 1* |
| | octet n* |

TABLE 4

| | | | | | | | |
|---|---|---|---|---|---|---|---|
| 8 | 7 | 6 | 5 | 4 | 3 | 2 | 1 |

| Rejection cause | | | MSAI | | MD | | octet 4 |
|---|---|---|---|---|---|---|---|
| 0 | 0 | 0 | 0 | MSCI | MTI | IPAE | octet 5 |

spare

| TMGI | octet 6 |
|---|---|
| | octet j |
| Source IP address information | octet j + 1* |
| | octet v* |
| Destination IP address information | octet v + 1* |
| | octet k* |
| MBS service area | octet k + 1* |
| | octet s* |
| MBS timers | octet s + 1* |
| | octet l* |
| MBS security container | octet l + 1* |
| | octet e* |

As shown in Table 4, the “MBS Decision (MD)” parameter can be set to “MBS service area update,” “MBS join is accepted,” “MBS join is rejected” or “Remove UE from MBS session.” The Reject cause is set to the reason when the MID is set to “MBS join is rejected” or “Remove UE from MBS session.” The “MBS service area” is set to the service area where the MBS service is applicable. This parameter can contain the MBS TAI list, the NR CGI list, or both, that identifies the service area(s) for a local MBS service. The “MBS timers” is used to indicate the back-off timer for joining the MBS session or the start time of this MBS session. The “MBS security container” includes the MBS Service Key Identifier, the MBS Service Key (MSK), the MBS Traffic Key Identifier (MTK ID) and the Encrypted MBS Traffic Key (Encrypted MTK).

As mentioned earlier, this disclosure includes various examples of how a MBS PDU session can be requested, modified, accepted, or rejected.

In some aspects, the AP sets or defines an MBS session context for the MBS PDU session by providing a set AT command to the modem. The set AT command can be referred to as an MBS session context (+CMSCONT) command or a +CMSCONT AT command. The set AT command can include various parameters, such as a context identifier (CID), an MBS session ID, MBS session ID type, and an MBS operation. In some implementations, the AP reads the parameters of a current setting for one or more MBS sessions by communicating a first read AT command, such as an +CMSCONT? or +CMSCONT? AT command, to the modem. In some implementations, the AP initiates a PDU session modification procedure for the MBS PDU session by communicating an AT command to the modem, such as a +CGCMOD command or a +CGCMOD AT command. The AP initiates a PDU session establishment procedure for the MBS PDU session by communicating an AT command to the modem, such as a +CGACT command or a +CGACT AT command. In some implementations, instead of providing two separate AT commands (such as the +CMSCONT command and the +CGACT command), the AP both sets the MBS session context and initiates the PDU session modification procedure by providing a single AT command, such as a MBS session operation (+CMOP) command or a +CMOP AT command, to the modem.

In some aspects, the AP reads dynamic parameters associated with one or more MBS sessions by providing a second read AT command to the modem. The second read AT command can be referred to as an MBS session read dynamic parameters (+CMSRDP) command or a +CMSRDP AT command. The second read AT command includes a CID of the MBS PDU session in order to identify the specific MBS PDU session. The modem can respond to the second read AT command by providing a response that indicates the one or more dynamic parameters associated with the MBS session. The dynamic parameters include a CID, a temporary mobile group identity (TMGI), an MBS tracking area identity list (MBS_TAI_list), an MBS cell global identifier list (MBS_CGI_list), a source IP address (Source_IP), a destination address (Destination_IP), an MBS session start time (MBS_Start_Time), an MBS session residual timer (MBS_residual_timer), an MBS service key (MSK), an MBS service key identifier (MSK_ID), an MBS traffic key identifier (MTK_ID), and an encrypted MBS traffic key (Enc_MTK).

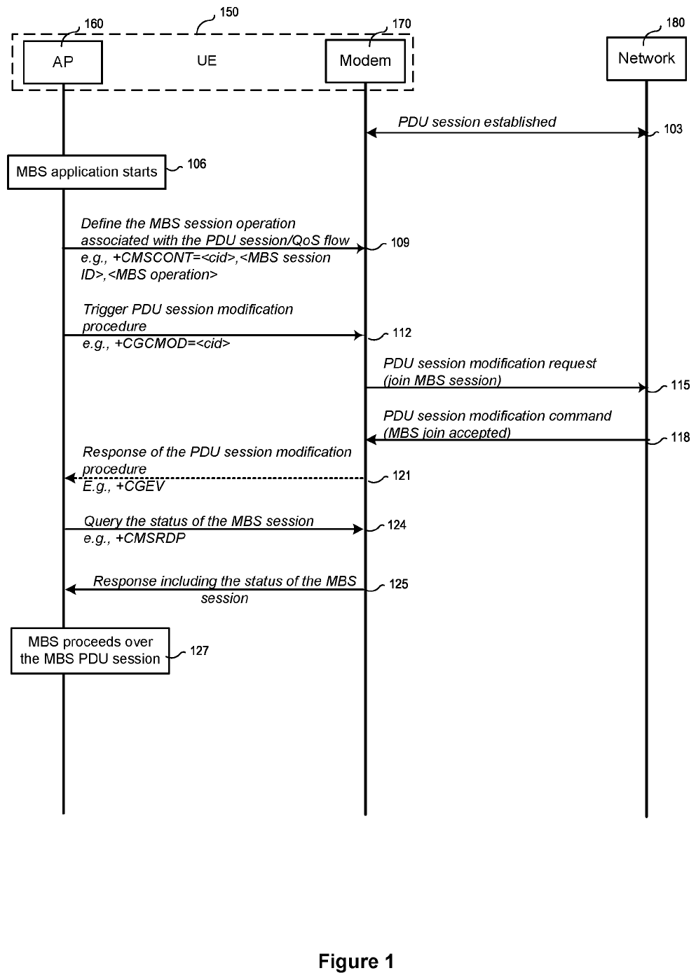

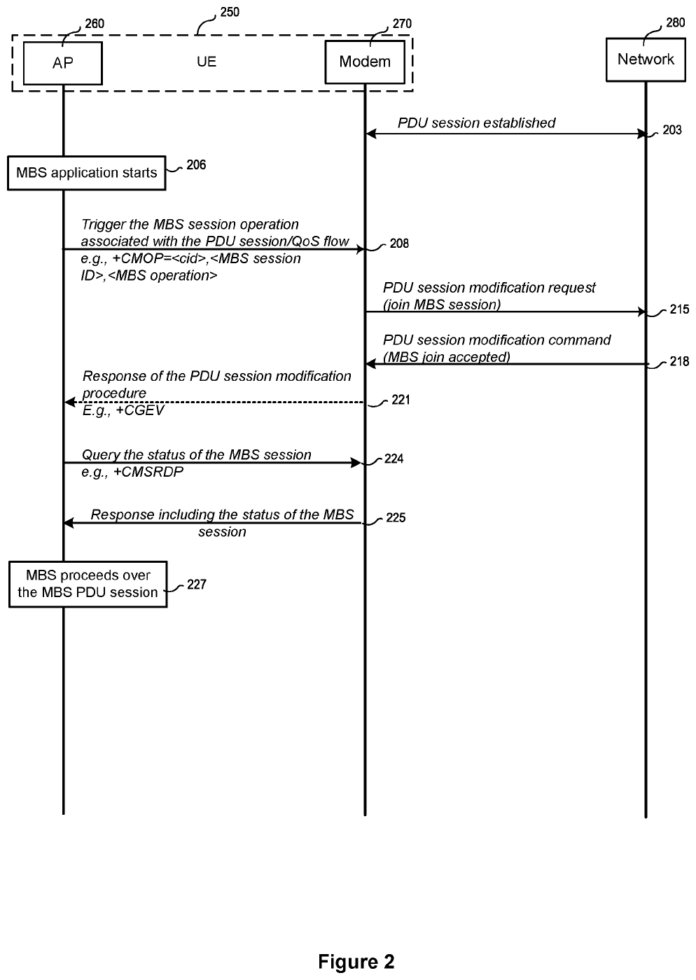

FIG. 1 is an example message flow for a UE to join an MBS over an existing PDU session where an interface between AP and modem includes one or more AT commands defining the MBS session operation and triggering the PDU session modification procedure, according to some implementations. As shown in FIG. 1, a UE 150 includes an AP 160 and a modem 170. The MBS application is running at the AP side while the protocol (i.e., 3GPP Non-Access-Stratum (NAS) protocol) for configuring the MBS session operation and exchange of parameters are implemented at the modem side. An interface between the AP 160 and modem 170 enables the MBS service. For example, the interface includes a physical interface and/or software interface. The physical interface can include a Peripheral Component Interconnect Express (PCIe), shared memory or Universal Serial Bus (USB), and the software interface can be a remote procedure (RPC) call interface or an AT command interface. In some implementations, a client software is run on the AP 160 and a server software is run on the modem 170 to enable communication (e.g., the commands described below) between the AP 160 and the modem 170 via the interface. A similar interface that enables the MBS service can be implemented in FIGS. 2-7.

In step 103, a PDU session suitable for the MBS service is established. In step 106, the MBS application starts and then checks whether there's a suitable PDU session established. To check whether there's a suitable PDU session exists, the AP 160 can read the DNN and the S-NSSAI of all the existing PDU sessions (such as by +CGCONTRDP command) and determine whether the DNN and the S-NSSAI match the required setting for the MBS session. In step 109, if the suitable PDU session exists, the AP 160 can send an AT command, such as an +CMSCONT command, to the modem 170 to define or set the MBS session context including the MBS session operation (i.e., join MBS session). For example, the +CMSCONT command can be a set AT command, such as a +CMSCONT=command. The set AT command can include at least a CID identifying the PDU session, an MBS session ID, and an MBS operation. The set AT command can also include an MBS session ID type. In some implementations, the modem 170 responds with an “OK” response message (not shown). For example, the AP 160 can wait for the OK response message before proceeding with a next AT command. In step 112, the AP 160 triggers the PDU session modification procedure by communicating an AT command to the modem 170, such as a +CGCMOD command. The modem 170 can request to join the MBS session by a NAS message, such as a PDU session modification request message, in step 115. In step 118, the network 180 accepts the MBS join request and returns a PDU session modification command message indicating the MBS join request is accepted. In some implementations, the modem 170 sends a response message for the PDU session modification procedure to the AP 160 in step 121. For example, the response message can be an AT command, such as a +CGEV command, to indicate the outcome of the MBS join request. In some implementations, the response message shown in step 121 is optional. In some implementations, the AP 160 waits for an OK message (not shown) before proceeding to the next step.

In step 124, the AP 160 can then query the status of the MBS session after the PDU session modification procedure is finished by sending a query message to the modem 170. In some implementations, the AP 160 queries the status of multiple MBS sessions by sending the query message to the modem 170. For example, the query message can be a read AT command, such as an +CMSRDP command, that reads dynamic parameters associated with one or more MBS sessions. The +CMSRDP command can include a CID of the MBS PDU session in order to identify the specific MBS PDU session. At step 125, the modem 170 can respond to the +CMSRDP command by providing a response message that indicates one or more dynamic parameters associated with the MBS session (or multiple MBS sessions). In some implementations, the dynamic parameters include the CID, a TMGI, an MBS_TAI_list, an MBS_CGI_list, a Source_IP, a Destination_IP, an MBS_Start_Time, an MBS_residual_timer, an MSK, an MSK_ID, an MTK_ID, and an Enc_MTK. At step 127, the MBS can proceed over the MBS PDU session.

FIG. 2 is an example message flow for a UE 250 to join an MBS over an existing PDU session where an interface between the AP 260 and the modem 270 includes a command to join an MBS over an existing PDU session, according to some implementations. In the example of FIG. 2, the UE 250 can join an MBS session over an existing PDU session. The PDU session that supports the MBS may be referred to as an MBS PDU session. Instead of defining the MBS PDU session and triggering the PDU session modification procedure in two steps (such as using two different commands, as shown in FIG. 1), the AP 260 can directly trigger the MBS session join request over PDU session modification procedure using a single AT command, such as the +CMOP command, as further described below.

In step 203, a PDU session suitable for the MBS service is established. In step 206, the MBS application starts and then checks for an established suitable PDU session. In step 208, if the suitable PDU session exists, the AP 260 can send an AT command, such as an +CMOP command, to the modem 270 to both define or set the MBS session context and trigger the PDU session modification procedure. For example, the +CMOP command can be a set AT command, such as a +CMOP=command. The set AT command can include at least a CID identifying the PDU session, an MBS session ID, and an MBS operation. The set AT command can also include an MBS session ID type. In some implementations, the modem 270 responds with an “OK” response message (not shown). The modem 270 can then request 215 to join the MBS session by a PDU session modification request message. In step 218, the network 280 accepts the MBS join request and returns a PDU session modification command message indicating acceptance of the MBS join request. In some implementations, in step 221, the modem 270 sends a response message for the PDU session modification procedure to the AP 260. For example, the response message can be an AT command, such as a +CGEV command, to indicate the outcome of the MBS session join request. In some implementations, the response message shown in step 221 is optional. In some implementations, the AP 260 waits for an OK message (not shown) before proceeding to the next step.

FIG. 2 elements 224-227 are similar to their counterparts in FIG. 1 elements 124-127.

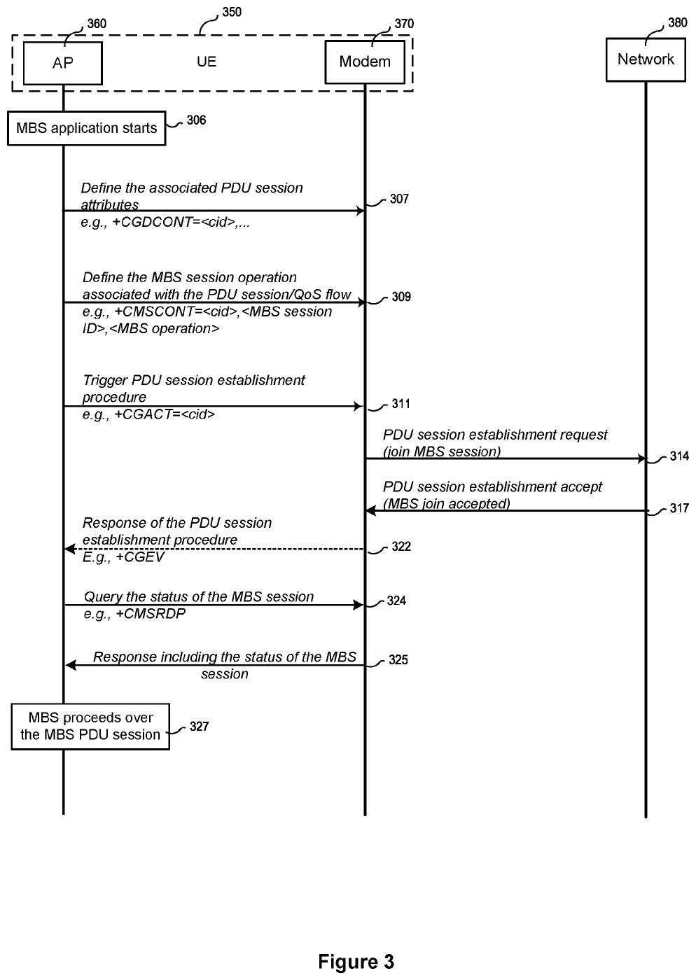

FIG. 3 is an example message flow for a UE 350 to join an MBS session and establish a new PDU session associating with the MBS session, according to some implementations. In the example of FIG. 3, in step 306, the MBS application starts and then checks whether there's a suitable PDU session established. The AP 360 determines there is no suitable PDU session existing when the MBS application starts. In step 307, the AP 360 configures a suitable PDU session by sending an AT command to the modem 370, such as a +CGDCONT=command that indicates a CID and the corresponding DNN and S-NSSAI for the MBS session. In step 309, the AP 360 can send an AT command, such as an +CMSCONT command, to the modem 370 to define or set the MBS session context including the MBS session operation (i.e., join MBS session). For example, the +CMSCONT command can be a set AT command, such as a +CMSCONT-command. The set AT command can include at least a CID identifying the PDU session, an MBS session ID, and an MBS operation. The set AT command can also include an MBS session ID type. In some implementations, the modem 370 responds with an “OK” response message (not shown). For example, the AP 360 can wait for the OK response message before proceeding with a next AT command.

In step 311, after the parameters for the PDU session establishment and the MBS PDU session are configured, the AP 360 triggers the PDU session establishment procedure for the MBS PDU session by communicating an AT command, such as a +CGACT command, to the modem 370. In step 314, the modem 370 can send a PDU session establishment request message to the network 380 to complete the PDU session establishment procedure and request to join the MBS session. In step 317, the network 380 accepts the MBS join request and returns a PDU session establishment accept message indicating the MBS join request is accepted. In some implementations, the modem 370 sends a response message for the PDU session establishment procedure to the AP 360 in step 322. For example, the response message can be an AT command, such as a +CGEV command, to indicate the outcome of the MBS session join request. In some implementations, the response message shown in step 322 is optional. FIG. 3 elements 324-327 are similar to their counterparts in FIG. 1 elements 124-127.

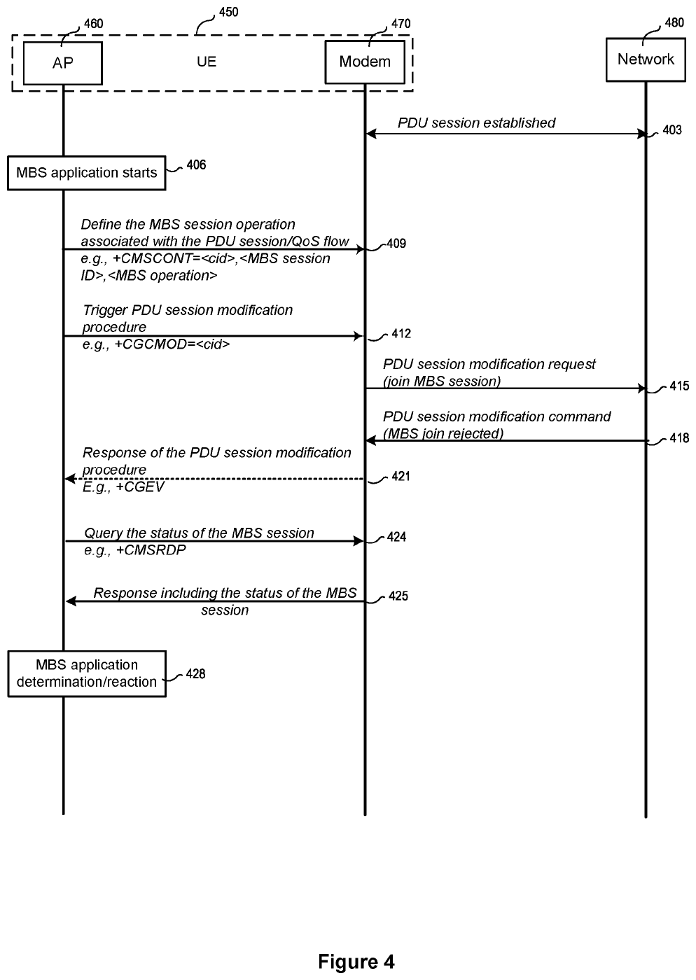

FIG. 4 illustrates an example scenario in which the MBS join request of a PDU session modification procedure is rejected by a network 480. In the example of FIG. 4, the network 480 can explicitly reject an MBS join request received from a UE 450, as further described below. Similar to the example of FIG. 1, in step 403, a PDU session suitable for the MBS service is established. In step 406, the MBS application starts and then checks whether there's a suitable PDU session established. In step 409, if the suitable PDU session exists, an AP 460 can send an AT command, such as an +CMSCONT command, to a modem 470 to define or set the MBS session context including the MBS session operation (i.e., join MBS session). For example, the +CMSCONT command can be a set AT command, such as a +CMSCONT=command. In step 412, the AP 460 triggers the PDU session modification procedure by communicating an AT command, such as a +CGCMOD command, to the modem 470. The modem 470 can request to join the MBS session by sending a PDU session modification request message in step 415. In step 418, the network 480 can reject the MBS join request and return a PDU session modification command message indicating the MBS join request is rejected. The network 480 can reject the MBS join request based on a condition, such as when UE is not within the service area, when the UE is not authorized/no subscription, when the MBS service is not started yet or otherwise unavailable, or due to congestion control/resource limitation, among other examples. In some implementations, the modem 470 sends a response message for the PDU session modification procedure to the AP 460 in step 421. For example, the response message can be an AT command, such as a +CGEV command, to indicate the outcome of the MBS session join request. In some implementations, the response message shown in step 421 is optional. In step 424, the AP 460 can then query the status of the MBS session after the PDU session modification procedure is finished by sending a query message to the modem 470. In some implementations, the AP 460 queries the status of multiple MBS sessions by sending the query message to the modem 470. For example, the query command can be a read AT command, such as an +CMSRDP command, that reads dynamic parameters associated with one or more MBS PDU sessions. If the query command is only for active MBS session (i.e., the UE is joining the MBS session), then the AP 460 can determine that the MBS join request fails. If the query command is applied to inactive MBS session (such as including the MBS session that the UE 450 tries to join but fails), then the AP 460 can also get the error due to the MBS join request not being successful, a back-off timer, and/or the MBS session start time. Based on those parameters, the AP 460 can determine to retry the MBS join request in a proper time or location. In the example scenario of FIG. 4, the MBS join request can be conveyed via the PDU session modification request. The PDU session modification request is an example NAS protocol message. At step 425, the modem 470 can respond to the +CMSRDP command by providing a response message that indicates one or more dynamic parameters associated with the PDU session (or multiple MBS sessions). At step 428, the AP 460 can proceed with the MBS application determination or reaction associated with the MBS PDU session.

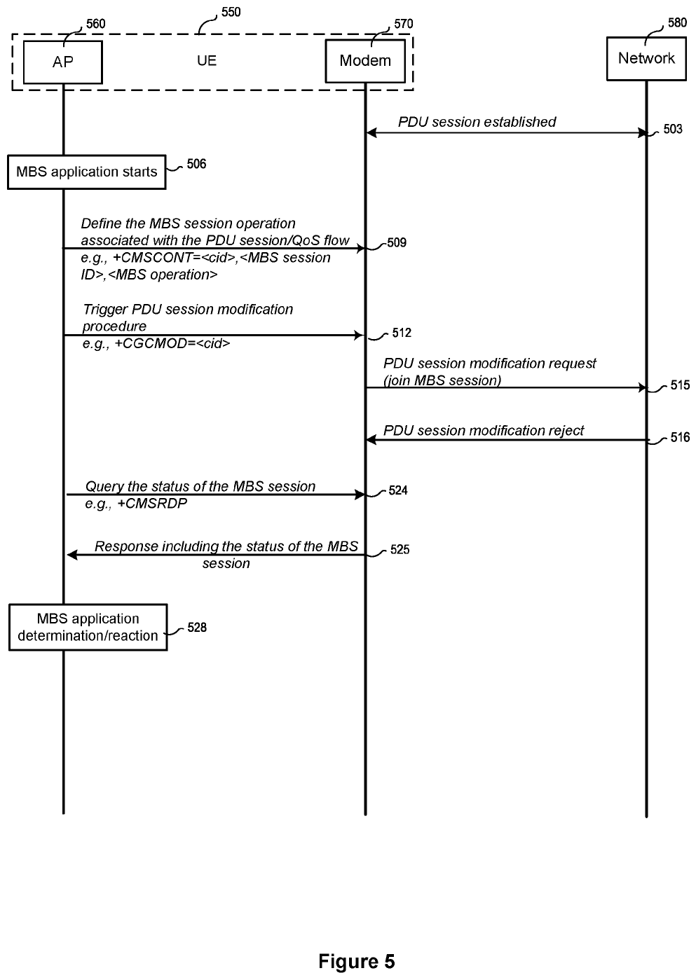

FIG. 5 is an example message flow for a UE 550 to join an MBS session over an existing PDU session but a network 580 rejects the PDU session modification request, according to some implementations. FIG. 5 is similar to FIG. 4, except that the network 580 implicitly rejects the MBS join request (sent in step 515) by sending a PDU session modification rejection message in step 516, as further described below. In step 503, a PDU session suitable for the MBS service is established. In step 506, the MBS application starts and then checks whether there's a suitable PDU session established. In step 509, if the suitable PDU session exists, an AP 560 can send an AT command, such as an +CMSCONT command, to a modem 570 to define or set the MBS session context including the MBS session operation (i.e., join MBS session). For example, the +CMSCONT command can be a set AT command, such as a +CMSCONT=command. In step 512, the AP 560 triggers the PDU session modification procedure by communicating an AT command, such as a +CGCMOD command, to the modem 570. The modem 570 can request to join the MBS session by sending a PDU session modification request message in step 515. In step 516, the network 580 can implicitly reject the MBS join request by sending a PDU session modification rejection message to the modem 570. In some implementations, the modem 570 communicates a message (such as an AT +CME ERROR command) to the AP 560 (not shown) after the modem 570 receives the PDU session modification reject message. FIG. 5 elements 524-525 are similar to their counterparts in FIG. 1 elements 124-125. At step 528, the AP 460 can proceed with the MBS application determination or reaction associated with the MBS PDU session.

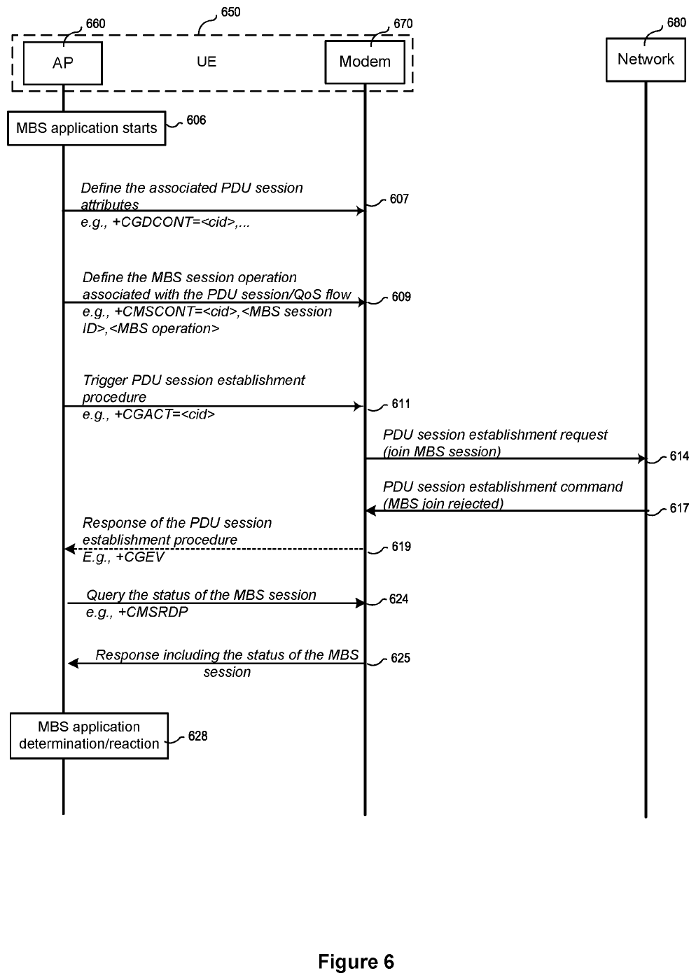

FIG. 6 illustrates an example scenario in which the MBS join request of a PDU session establishment procedure is rejected by a network 680. In the example of FIG. 6, the network 680 can explicitly reject an MBS join request received from a UE 650, as further described below. Similar to the example of FIG. 3, in step 606, the MBS application starts and then checks whether there's a suitable PDU session established. The AP 660 determines there is no suitable PDU session existing when the MBS application starts. In step 607, an AP 660 configures a suitable PDU session by sending an AT command, such as a +CGDCONT=command, to a modem 670 that indicates a CID and the corresponding DNN and S-NSSAI for the MBS session. In step 609, the AP 660 can send an AT command, such as an +CMSCONT command, to the modem 670 to define or set the MBS session context including the MBS session operation (i.e., join MBS session). For example, the +CMSCONT command can be a set AT command, such as a +CMSCONT=command. In step 611, after the parameters for the PDU session establishment and the MBS PDU session are configured, the AP 660 triggers the PDU session establishment procedure for the MBS PDU session by communicating an AT command, such as a +CGACT command, to the modem 670. In step 614, the modem 670 can send a PDU session establishment request message to the network 680 to complete the PDU session establishment procedure and request to join the MBS session. In step 617, the network 680 can reject the MBS join request and return a PDU session modification command message indicating the MBS join request is rejected. The network 680 can reject the MBS join request based on a condition, such as when UE is not within the service area, when the UE is not authorized/no subscription, when the MBS service is not started yet or otherwise unavailable, or due to congestion control/resource limitation, among other examples. In some implementations, the modem 670 sends a response message for the PDU session establishment procedure to the AP 660 in step 619. For example, the response message can be an AT command, such as a +CGEV command, to indicate the outcome of the MBS session join request. In some implementations, the response message shown in step 619 is optional.

In step 624, the AP 660 can then query the status of the MBS session after the PDU session establishment procedure is finished by sending a query message to the modem 670. In some implementations, the AP 660 queries the status of multiple MBS sessions by sending the query message to the modem 670. For example, the query command can be a read AT command, such as an +CMSRDP command, that reads dynamic parameters associated with one or more MBS PDU sessions. If the query command is only for active MBS session (i.e., the UE is joining the MBS session), then the AP 660 can determine that the MBS join request fails. If the query command is applied to inactive MBS session (such as including the MBS session that the UE 650 tries to join but fails), then the AP 660 can also get the error due to the MBS join request not being successful, a back-off timer, and/or the MBS session start time. Based on those parameters, the AP 660 can determine to retry the MBS join request in a proper time or location. In the example scenario of FIG. 6, the MBS join request can be conveyed via the PDU session establishment request. The PDU session establishment request is an example NAS protocol message. At step 625, the modem 670 can respond to the +CMSRDP command by providing a response message that indicates one or more dynamic parameters associated with the MBS session (or multiple MBS sessions). At step 628, the AP 660 can proceed with the MBS application determination or reaction associated with the MBS PDU session.

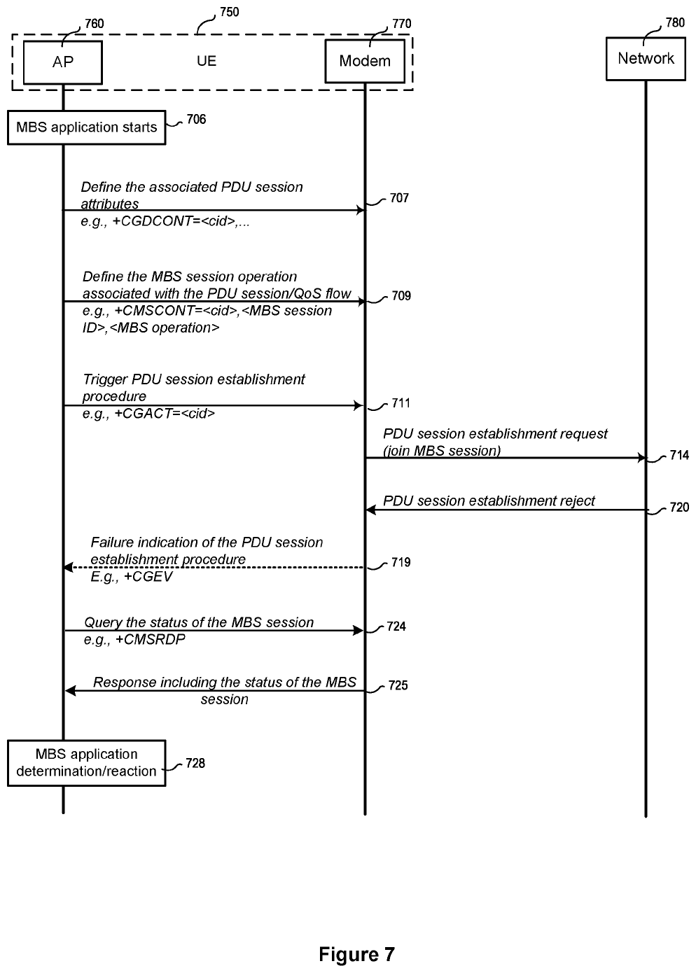

FIG. 7 is an example message flow for a UE 750 to join an MBS session and establish a new PDU session associating with the MBS session but a network 780 rejects the PDU session establishment request, according to some implementations. FIG. 7 elements 706-714 are similar to their counterparts in FIG. 3 elements 306-314. The network 780 can respond with a PDU session establishment accept message (such as shown in step 317 of FIG. 3) or a PDU session establishment reject message (as shown in step 720 of FIG. 7). As described with reference to FIGS. 4 and 6, the network 780 can reject the PDU session establishment based on a condition (such as congestion control/resource limitation, the UE not being authorized/no subscription, or the request PDU session being a non-allowable duplication, among other examples). In some implementations, the modem 770 sends 719 a response message for the PDU session establishment procedure to the AP 760. For example, the response message can be an AT command, such as a +CGEV command, to indicate the outcome of the MBS session join request, in this case the failure of the PDU session establishment procedure. In some implementations, the response message shown in step 719 is optional. FIG. 7 elements 724-725 are similar to their counterparts in FIG. 1 elements 124-125. At step 728, the AP 660 can proceed with the MBS application determination or reaction associated with the MBS PDU session.

Although not illustrated in FIGS. 4-7, some implementations of the protocol between the modem and the AP include additional messages. For example, when the modification procedure is not successful (as in step 418 of FIG. 4) or the PDU session establishment procedure is not successful (as in step 617 of FIG. 6), the modem (such as the modem 470 or the modem 670) can send an “OK” command indicating the outcome of the PDU session. Additionally, or alternatively, the modem (such as the modem 470 or the modem 670) can send a command (such as an AT +CGEV command) to indicate the rejected outcome of the MBS join request. In some implementations, the OK command (for PDU session) precedes or follows the +CGEV command (for MBS join request rejected). In some implementations, an OK message (from the modem or the AP) is used as an acknowledgement responsive to receiving a command (from the other one of the modem or the AP).

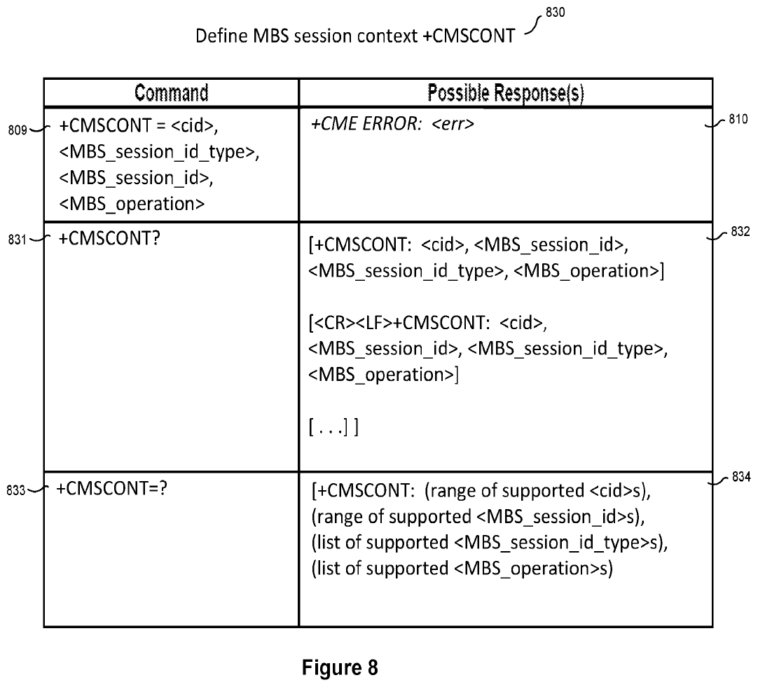

FIGS. 8-11 include examples of interface commands (referred to as attention, or AT, commands). The example AT commands can be used by an AP of a UE to communicate with a modem of the UE.

In FIG. 8, an example AT command has a +CMSCONT command syntax 830 that can define or set an MBS PDU session, according to some implementations. The +CMSCONT-command 809 is a set AT command that is used to define or set the MBS session context of the MBS PDU session. As shown in FIG. 8, the +CMSCONT=command 809 includes various parameters for the MBS PDU session including a CID, an MBS session ID, an MBS session ID type, and an MBS operation. If there is an error in setting or defining the MBS session context, an error response message can be received from the modem, such as a +CME ERROR message 810. The +CME ERROR message 810 can include one or more error (err) values to indicate one or more types of errors. The +CMSCONT? command 831 is a read AT command that is used to read the parameters of a current setting for one or more MBS sessions. As shown in FIG. 8, the modem can respond to the +CMSCONT? command 831 received from the AP by sending a response message 832 including the various parameters of the current setting for the one or more MBS sessions.

In some implementations, a CID field of the +CMSCONT=command 809 indicates a quality of service (QOS) flow definition, an evolved packet system (EPS) traffic flow definition, and a packet data protocol (PDP) context definition. In some implementations, an MBS session ID field of the +CMSCONT=command 809 indicates the MBS session ID for Internet Protocol version 4 (IPv4) and Internet Protocol version 6 (IPv6) multicast addresses having a format that includes a source_IP_address and a destination_IP_address. In some implementations, an MBS session ID type field of the +CMSCONT=command 809 is populated with either a first value to indicate a temporary mobile group identity (TMGI), a second value to indicate a source specific IP multicast address for IPV4, or a third value to indicate a source specific IP multicast address for IPV6. In some implementations, an MBS operation field of the +CMSCONT=command 809 is populated with either a first value to indicate joining the MBS PDU session or a second value to indicate leaving the MBS PDU session.

The +CMSCONT=? command 833 is a test AT command that is used to request the modem to return the ranges of the supported parameters (for the MBS PDU session) as compound values. As shown in FIG. 8, the modem can respond to the +CMSCONT=? command 833 received from the AP by sending a response message 834 including the ranges of the supported parameters for the MBS PDU session.

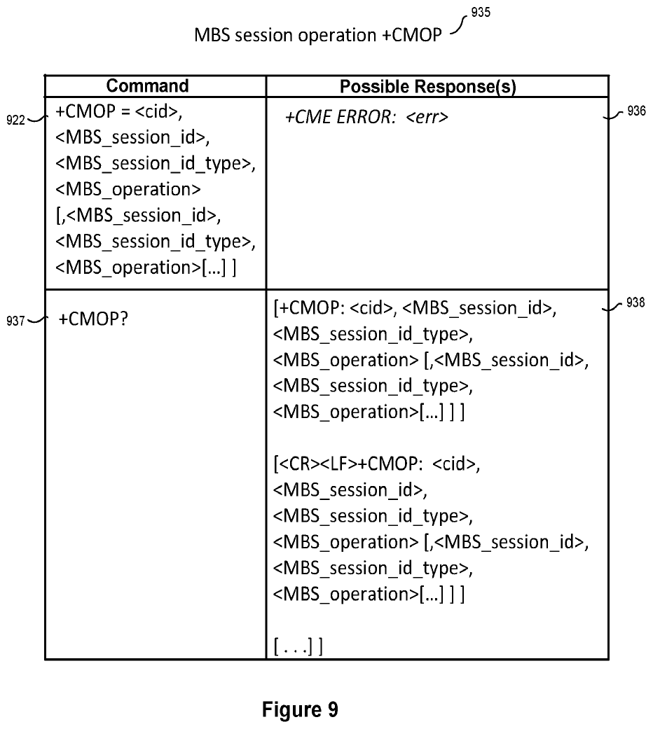

In FIG. 9, an example AT command is shown having a +CMOP command syntax 935 that can both define or set the MBS session context for the MBS PDU session and trigger a PDU session modification procedure, according to some implementations. As shown in FIG. 9, the +CMOP=command 922 includes various parameters for the MBS PDU session including a CID, an MBS session ID, an MBS session ID type, and an MBS operation. If there is an error in setting or defining the MBS session context, an error response message can be received from the modem, such as a +CME ERROR message 936. The +CME ERROR message 936 can include one or more error (err) values to indicate one or more types of errors. The +CMOP? command 937 is a read AT command that is used to read the parameters of a current setting for one or more MBS sessions. As shown in FIG. 9, the modem can respond to the +CMOP? command 937 received from the AP by sending a response message 938 including the various parameters of the current setting for the one or more MBS sessions.

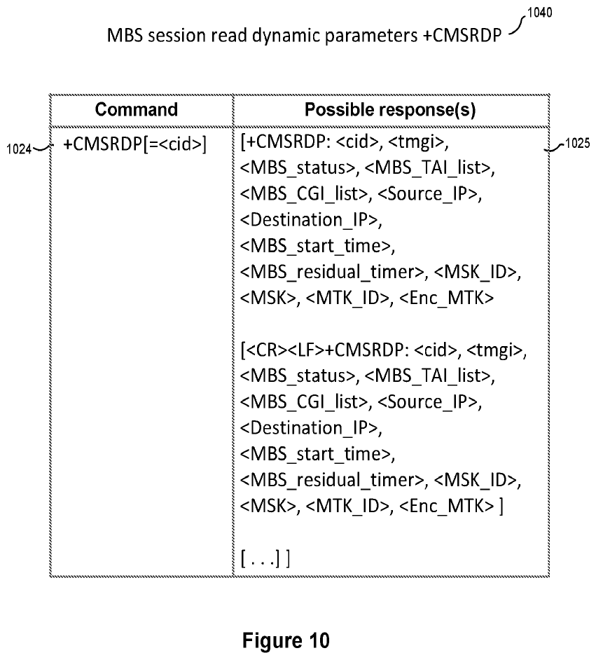

In FIG. 10, an example AT command is shown having a +CMSRDP command syntax 1040 that can query the status of one or more active MBS session, according to some implementations. As shown in FIG. 10, the query command can be an execution AT command, such as an +CMSRDP=command 1024, that reads dynamic parameters for one or more MBS sessions. The +CMSRDP=command can include a CID of the MBS PDU session in order to identify the specific MBS PDU session. In some implementations, the dynamic parameters can include the CID, a TMGI, an MBS_TAI_list, an MBS_CGI_list, a Source_IP, a Destination_IP, an MBS_Start_Time, an MBS_residual_timer, an MSK, an MSK_ID, an MTK_ID, and an Enc_MTK. As shown in FIG. 10, the modem can respond to the +CMSRDP=command 1024 received from the AP by sending a response message 1025 including the various dynamic parameters for the one or more active MBS sessions associated with the CID.

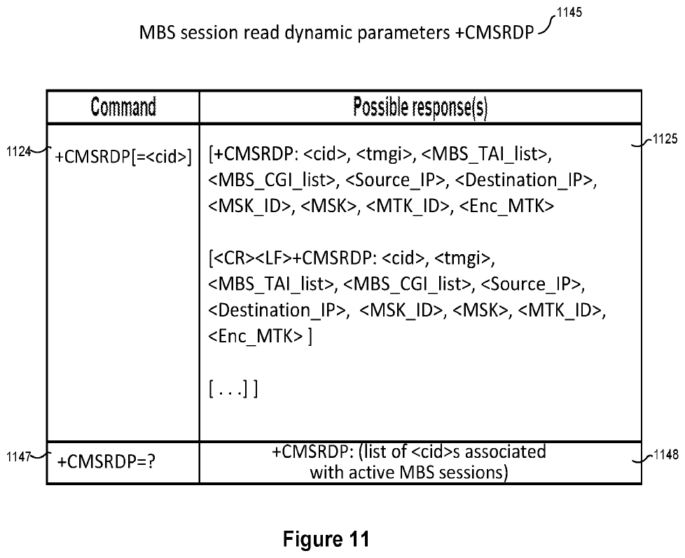

In FIG. 11, an example AT command is shown having a +CMSRDP command syntax 1045 that can query the status of one or more active MBS sessions, according to some implementations. As shown in FIG. 11, the query command can be an execution AT command, such as an +CMSRDP=command 1024, that reads dynamic parameters for one or more MBS sessions. The +CMSRDP=command can include a CID of the MBS PDU session in order to identify the specific MBS PDU session. In some implementations, the dynamic parameters can include the CID, a TMGI, an MBS_TAI_list, an MBS_CGI_list, a Source_IP, a Destination_IP, an MSK, an MSK_ID, an MTK_ID, and an Enc_MTK. As shown in FIG. 11, the modem can respond to the +CMSRDP=command 1024 received from the AP by sending a response message 1025 including the various dynamic parameters for the one or more active MBS sessions associated with the CID. The +CMSRDP-? command 1147 is a test AT command that is used to request the modem to return a list of CIDs associated with the one or more active MBS PDU sessions. As shown in FIG. 11, the modem can respond to the +CMSRDP=? command 1147 received from the AP by sending a response message 1148 including the list of CIDs associated with the one or more active MBS PDU sessions.

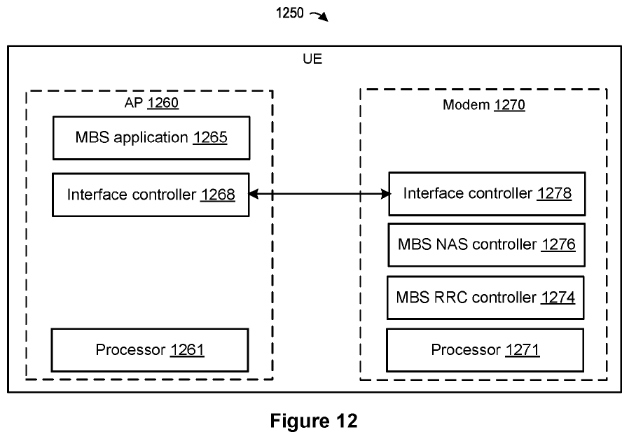

FIG. 12 is an example UE 1250 including an AP 1260 and a modem 1270, which may be an example implementation of the UEs described above in FIGS. 1-7. The modem 1270 includes a processor 1271, an MBS RRC controller 1274, an MBS NAS controller 1276 and an interface controller 1278. The processor 1271 process data that the UE 1250 will transmit in the uplink direction, or processes data received by UE 1250 in the downlink direction. The MBS Radio Resource Controller (RRC) controller 1274 can be configured to support RRC configurations, procedures and messaging associated with MBS procedures, and/or to support the necessary operations. The MBS NAS controller 1276 can be configured to support NAS configurations, procedures and messaging associated with MBS procedures, and/or to support the necessary operations. The interface controller 1278 manages communication of messages (e.g., AT commands and/or RPC function calls) exchanged between the modem 1270 and AP 1260.

The AP 1260 includes a processor 1261, an interface controller 1268 and an MBS application 1265. The processor 1261 is configured to run an operating system (e.g., Android, IOS, Windows or Linux). The interface controller 1268 manages communication of messages (e.g., AT commands and/or RPC function calls) exchanged between the modem 1270 and AP 1260. The interface controller 1268 can be run on the processor 1261. The MBS application 1265 is configured to receive one or more MBS services. For example, the MBS application 1265 includes an IP streaming application or software update application.

In some implementations, the modem 1270 is referred to as a terminal adapter (TA) and the AP 1260 is referred to as a terminal equipment (TE).

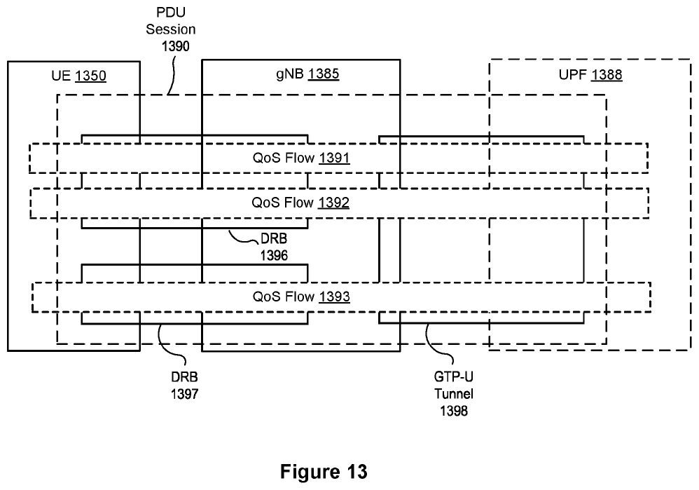

FIG. 13 is an example network, including a UE 1350, a Next Generation NodeB or gNodeB (gNB) 1385, and a User Plane Function (UPF) 1388, which may be an example network that implements the features described above in FIGS. 1-12. A PDU session 1390 can be established as described above with reference to FIGS. 1-7. As described previously, a PDU session 1390 that supports MBS can be referred to as an MBS PDU session. The PDU session 1390 can be implemented across the UE 1350, the gNB 1385 and the UPF 1388 via one or more data radio bearers (DRB) between the UE 1350 and the gNB 1385, such as DRB 1396 and DRB 1397, and a GTP-U tunnel 1398 between the gNB 1385 and the UPF 1388. The PDU session 1390 also includes one or more quality of service (QOS) flows, such as QoS flows 1391-1393. The MBS that is supported by the PDU session 1390 is also supported by the QoS flows 1391-1393, the DRB 1396, the DRB 1397, and the GTP-U tunnel 1398. Various MBS applications can be supported by the MBS PDU session, such as IP streaming applications, Voice-over-IP (VOIP) applications, and software update applications, among others.

The following additional considerations apply to this disclosure.

Example AT commands described herein include:
+CMSCONT: Define MBS session context +CMSCONT, please refer to FIG. 8.
+CGCMOD: PDP context modify +CGCMOD.
+CGEV: used to indicate bearer operations status.
+CMSRDP: MBS session read dynamic parameters +CMSRDP, please refer to FIGS. 10 and 11.
+CMOP: MBS session operation +CMOP, please refer to FIG. 9.
+CGACT: PDP context activate or deactivate +CGACT.

Although the AT commands above are used as examples to explain this disclosure, it should be noted that these examples can be applied to other interface(s) such as remote procedure call (RPC) interface(s). For example, an AT command sent by the AP to the modem can be replaced by one or more RPC function calls and the parameters (i.e., arguments) of the AT command are the arguments of the one or more RPC function calls. Return result(s) in a response of the AT command are return result(s) of the one or more RPC function calls. In another example, two or more AT commands can be combined as one single RPC function call and the parameters (i.e., arguments) of the AT commands are the arguments of the RPC function call. Return result(s) in responses of the AT commands are return results of the RPC function call.

FIGS. 1-13 and the operations described herein are examples meant to aid in understanding example implementations and should not be used to limit the potential implementations or limit the scope of the claims. Some implementations may perform additional operations, fewer operations, operations in parallel or in a different order, and some operations differently.

The foregoing disclosure provides illustration and description but is not intended to be exhaustive or to limit the aspects to the precise form disclosed. Modifications and variations may be made in light of the above disclosure or may be acquired from practice of the aspects. While the aspects of the disclosure have been described in terms of various examples, any combination of aspects from any of the examples is also within the scope of the disclosure. The examples in this disclosure are provided for pedagogical purposes. Alternatively, or in addition to the other examples described herein, examples include any combination of the following implementation options (enumerated as clauses for clarity).

### CLAUSES

Clause 1. A method for managing a multicast and broadcast service (MBS) protocol data unit (PDU) session by a user equipment (UE), comprising: communicating one or more attention (AT) commands for the MBS PDU session from an application processor (AP) of the UE to a modem of the UE.

Clause 2. The method of clause 1, wherein communicating the one or more AT commands for the MBS PDU session comprises: setting an MBS session context of the MBS PDU session by communicating the MBS session context via a first AT command from the AP to the modem; and requesting the modem to initiate a PDU session establishment or a PDU session modification for the MBS PDU session.

Clause 3. The method of clause 2, wherein the setting the MBS session context includes setting one or more parameters of the MBS session context for the MBS PDU session.

Clause 4. The method of clause 3, further comprising reading the one or more parameters of a current setting for an MBS session by communicating a second AT command from the AP to the modem.

Clause 5. The method of any one of clauses 3-4, wherein the one or more parameters include at least one of: a context identifier (CID), an MBS session ID, MBS session ID type, or an MBS operation.

Clause 6. The method of any one of clauses 2-5, wherein the first AT command includes a CID field indicating a quality of service (QOS) flow definition, an evolved packet system (EPS) traffic flow definition, and a packet data protocol (PDP) context definition.

Clause 7. The method of any one of clauses 2-6, wherein the first AT command includes an MBS session ID field indicating the MBS session ID for Internet Protocol version 4 (IPv4) and Internet Protocol version 6 (IPv6) multicast addresses having a format that includes a source_IP_address and a destination_IP_address.

Clause 8. The method of any one of clauses 2-7, wherein the first AT command includes an MBS session ID type field populated with either a first value to indicate a temporary mobile group identity (TMGI), a second value to indicate a source specific IP multicast address for IPV4, or a third value to indicate a source specific IP multicast address for IPV6.

Clause 9. The method of any one of clauses 2-8, wherein the first AT command includes an MBS operation field populated with either a first value to indicate joining the MBS PDU session or a second value to indicate leaving the MBS PDU session.

Clause 10. The method of any one of clauses 4-9, wherein the reading the one or more parameters of the current setting for the MBS session includes receiving a response from the modem indicating the one or more parameters of the current setting for the MBS session.

Clause 11. The method of clause 1, wherein communicating the one or more AT commands for the MBS PDU session comprises: setting an MBS session context of the MBS PDU session and requesting the modem to initiate an PDU session modification of the MBS PDU session by communicating a first AT command from the AP to the modem.

Clause 12. The method of clause 1, wherein communicating the one or more AT commands for the MBS PDU session comprises: setting an MBS session context of the MBS PDU session by communicating the MBS session context via a first AT command from the AP to the modem; and requesting the modem to initiate either a PDU session modification or a PDU session establishment by communicating either a second AT command or a third AT command, respectively, from the AP to the modem.

Clause 13. The method of clause 12, wherein the requesting the modem to initiate either the PDU session modification or the PDU session establishment comprises: the communicating the second AT commend if the PDU session has been established, or the communicating the third AT command if the PDU session has not been established.

Clause 14. The method of clause 1, wherein the communicating the one or more AT commands for the MBS PDU session comprises: reading one or more dynamic parameters of the MBS session by communicating a first AT command from the AP to the modem.

Clause 15. The method of clause 14, wherein the first AT command includes a CID of the MBS PDU session.

Clause 16. The method of any one of clauses 14-15, wherein the reading the one or more dynamic parameters includes receiving a response from the modem indicating the one or more dynamic parameters of the MBS session.

Clause 17. The method of any one of clauses 14-16, wherein the one or more dynamic parameters includes at least one of the CID, a temporary mobile group identity (TMGI), an MBS tracking area identity list (MBS_TAI_list), an MBS cell global identifier list (MBS_CGI_list), a source_IP_address (Source_IP), a destination address (Destination_IP), an MBS session start time (MBS_Start_Time), an MBS session residual timer (MBS_residual_timer), an MBS service key (MSK), an MBS service key identifier (MSK_ID), an MBS traffic key identifier (MTK_ID), and an encrypted MBS traffic key (Enc_MTK).

Clause 18. A User Equipment (UE), comprising: a modem; and an application processor (AP) coupled with the modem and configured to perform any one of the methods of clauses 1-17.

Clause 19. A method for managing a multicast and broadcast service (MBS) protocol data unit (PDU) session by a user equipment (UE), comprising: receiving, at a modem of the UE, one or more attention (AT) commands for the MBS PDU session from an application processor (AP) of the UE.

Clause 20. The method of clause 19, wherein the receiving the one or more AT commands for the MBS PDU session comprises: receiving, at the modem, a first AT command from the AP, the first AT command requesting the modem to set an MBS session context of the MBS PDU session; and initiating a PDU session establishment or a PDU session modification for the MBS PDU session.

Clause 21. The method of clause 20, wherein the first AT command includes one or more parameters of the MBS session context for the MBS PDU session.

Clause 22. The method of clause 21, further comprising receiving, at the modem, a second AT command from the AP, the second AT command requesting the modem to send the one or more parameters of a current setting for an MBS session.

Clause 23. The method of clause 22, further comprising communicating, from the modem to the AP, a response indicating the one or more parameters of the current setting for the MBS session.

Clause 24. The method of any one of clauses 21-23, wherein the one or more parameters include at least one of: a context identifier (CID), an MBS session ID, MBS session ID type, or an MBS operation.

Clause 25. The method of clause 20, wherein the initiating the PDU session establishment or the PDU session modification for the MBS PDU session includes: initiating the PDU session modification in response to receiving a second AT command from the AP, or initiating the PDU session establishment in response to receiving a third AT command from the AP.

Clause 26. The method of clause 19, wherein the receiving the one or more AT commands for the MBS PDU session comprises: receiving, at the modem, a first AT command from the AP, the first AT command requesting the modem to set an MBS session context of the MBS PDU session and to initiate an PDU session modification of the MBS PDU session.

Clause 27. The method of clause 19, wherein the receiving the one or more AT commands for the MBS PDU session comprises: receiving, at the modem, a first AT command from the AP, the first AT command requesting the modem to send one or more dynamic parameters of the MBS session.

Clause 28. The method of clause 27, further comprising communicating, from the modem to the AP, a response indicating the one or more dynamic parameters of the MBS session.

Clause 29. The method of any one of clauses 27-28, wherein the one or more dynamic parameters includes at least one of the CID, a temporary mobile group identity (TMGI), an MBS tracking area identity list (MBS_TAI_list), an MBS cell global identifier list (MBS_CGI_list), a source_IP_address (Source_IP), a destination address (Destination_IP), an MBS session start time (MBS_Start_Time), an MBS session residual timer (MBS_residual_timer), an MBS service key (MSK), an MBS service key identifier (MSK_ID), an MBS traffic key identifier (MTK_ID), and an encrypted MBS traffic key (Enc_MTK).

Clause 30. A User Equipment (UE), comprising: an application processor (AP); and a modem coupled with the AP and configured to perform any one of the methods of clauses 19-29.

Another innovative aspect of the subject matter described in this disclosure can be implemented as a wireless communication device of a UE. The wireless communication device may include at least one interface and a processing system communicatively coupled with the at least one interface. The processing system may be configured to implement any one of the above clauses.

Another innovative aspect of the subject matter described in this disclosure can be implemented as a portable electronic device comprising a wireless communication device, a plurality of antennas coupled to the at least one transceiver to wirelessly transmit signals output from the at least one transceiver and a housing that encompasses the wireless communication device, the at least one transceiver and at least a portion of the plurality of antennas. The wireless communication device may include at least one interface and a processing system communicatively coupled with the at least one interface. The processing system may be configured to implement any one of the above clauses.

Another innovative aspect of the subject matter described in this disclosure can be implemented as a machine-readable medium having processor-readable instructions stored therein that, when executed by a processing system of a UE, cause the UE to implement any one of the above clauses.

Another innovative aspect of the subject matter described in this disclosure can be implemented as an apparatus. The apparatus may include means for implementing any one of the above clauses.

A user device in which the techniques of this disclosure can be implemented (such as the UE) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases can be embedded in an electronic system such as the head unit of a vehicle or an advanced driver assistance system (ADAS). Still further, the user device can operate as an internet-of-things (IOT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules can be software modules (such as code stored on non-transitory machine-readable medium) or hardware modules. A hardware module is a tangible unit capable of performing certain operations and can be configured or arranged in a certain manner. A hardware module can comprise dedicated circuitry or logic that is permanently configured (such as a special-purpose processor, such as a field programmable gate array (FPGA) or an application-specific integrated circuit (ASIC)) to perform certain operations. A hardware module can also comprise programmable logic or circuitry (such as encompassed within a general-purpose processor or other programmable processor) that is temporarily configured by software to perform certain operations. The decision to implement a hardware module in dedicated and permanently configured circuitry, or in temporarily configured circuitry (such as configured by software) can be driven by cost and time considerations.

When implemented in software, the techniques can be provided as part of the operating system, a library used by multiple applications, a particular software application, etc. The software can be executed by one or more general-purpose processors or one or more special-purpose processors.

1-20. (canceled)

21. A method for managing a multicast and broadcast service (MBS) protocol data unit (PDU) session by a user equipment (UE), comprising:
communicating one or more attention (AT) commands for the MBS PDU session from an application processor (AP) of the UE to a modem of the UE:
wherein communicating the one or more AT commands for the MBS PDU session comprises:
setting one or more parameters of an MBS session context of the MBS PDU session by communicating the MBS session context via a first AT command from the AP to the modem; and
requesting the modem to initiate a PDU session establishment or a PDU session modification for the MBS PDU session.

22. The method of claim 21, wherein the first AT command comprises a +CMSCONT command.

23. The method of claim 21, further comprising:
reading the one or more parameters of a current setting for the MBS session context by communicating a second AT command from the AP to the modem.

24. The method of claim 21, wherein:
the one or more parameters include at least one of: a context identifier (CID), an MBS session ID, MBS session ID type, or an MBS operation.

25. The method of claim 21, wherein:
the requesting the modem to initiate the PDU session establishment or the PDU session modification for the MBS PDU session comprises communicating either a second AT command or a third AT command from the AP to the modem.

26. The method of claim 25, wherein the second AT command or the third AT command comprises a +CGCMOD command.

27. The method of claim 21, wherein the first AT command includes at least one of:
a context identifier (CID) field indicating a quality of service (QOS) flow definition, an evolved packet system (EPS) traffic flow definition, and a packet data protocol (PDP) context definition;
an MBS session ID field indicating the MBS session ID for Internet Protocol version 4 (IPv4) and Internet Protocol version 6 (IPv6) multicast addresses having a format that includes a source_IP_address and a destination_IP_address;
an MBS session ID type field populated with either a first value to indicate a temporary mobile group identity (TMGI), a second value to indicate a source specific IP multicast address for IPV4, or a third value to indicate a source specific IP multicast address for IPV6; or
an MBS operation field populated with either a first value to indicate joining the MBS PDU session or a second value to indicate leaving the MBS PDU session.

28. The method of claim 21, further comprising:
communicating a second AT command from the AP to the modem; and
receiving a response from the modem indicating one or more parameters of a current setting for the MBS session context.

29. The method of claim 21, wherein the communicating the one or more AT commands for the MBS PDU session comprises:
reading one or more dynamic parameters of the MBS PDU session by communicating a read AT command from the AP to the modem, wherein the read AT command comprises a +CMSRDP command.

30. The method of claim 29, wherein:
the read AT command includes a context identifier (CID) of the MBS PDU session.

31. The method of claim 29, wherein the reading the one or more dynamic parameters includes receiving a response from the modem indicating the one or more dynamic parameters of the MBS PDU session.

32. The method of claim 29, wherein:
the one or more dynamic parameters includes at least one of a context identifier (CID), a temporary mobile group identity (TMGI), an MBS tracking area identity list (MBS_TAI_list), an MBS cell global identifier list (MBS_CGI_list), a source_IP_address (Source_IP), a destination address (Destination_IP), an MBS session start time (MBS_Start_Time), an MBS session residual timer (MBS_residual_timer), an MBS service key (MSK), an MBS service key identifier (MSK_ID), an MBS traffic key identifier (MTK_ID), or an encrypted MBS traffic key (Enc_MTK).

33. A method for managing a multicast and broadcast service (MBS) protocol data unit (PDU) session by a user equipment (UE), comprising:
receiving, at a modem of the UE, one or more attention (AT) commands for the MBS PDU session from an application processor (AP) of the UE;
wherein the receiving the one or more AT commands for the MBS PDU session comprises:
receiving, at the modem, a first AT command from the AP, the first AT command requesting the modem to set an MBS session context of the MBS PDU session; and
initiating a PDU session establishment or a PDU session modification for the MBS PDU session.

34. The method of claim 33, wherein the first AT command includes one or more parameters of the MBS session context for the MBS PDU session, further comprising:
receiving, at the modem, a second AT command from the AP, the second AT command requesting the modem to send the one or more parameters of a current setting for the MBS session context; and
communicating, from the modem to the AP, a response indicating the one or more parameters of the current setting for the MBS session context.

35. The method of claim 33, wherein:
the one or more parameters include at least one of: a context identifier (CID), an MBS session ID, MBS session ID type, or an MBS operation.

36. The method of claim 33, wherein the initiating the PDU session establishment or the PDU session modification for the MBS PDU session includes:
initiating the PDU session modification in response to receiving a second AT command from the AP, or
initiating the PDU session establishment in response to receiving a third AT command from the AP.

37. The method of claim 33, wherein the receiving the one or more AT commands for the MBS PDU session comprises:
receiving, at the modem, a read AT command from the AP, the read AT command requesting the modem to send one or more dynamic parameters of the MBS PDU session; and
communicating, from the modem to the AP, a response indicating the one or more dynamic parameters of the MBS PDU session.

38. A User Equipment (UE), comprising:
an application processor (AP) configured to:
communicate, to a modem of the UE, one or more attention (AT) commands for a multicast and broadcast service (MBS) protocol data unit (PDU) session;
set one or more parameters of an MBS session context of the MBS PDU session by communicating the MBS session context via a first AT command from the AP to the modem; and
request the modem to initiate a PDU session establishment or a PDU session modification for the MBS PDU session.

39. The UE of claim 38, further comprising:
the modem, coupled with the AP, and configured to:
receive the one or more AT commands for the MBS PDU session from the AP;
receive the first AT command from the AP, the first AT command requesting the modem to set the MBS session context of the MBS PDU session; and
initiate the PDU session establishment or the PDU session modification for the MBS PDU session.

40. The UE of claim 38, wherein the first AT command comprises a +CMSCONT command, and wherein the first AT command includes at least one of:
a context identifier (CID) field indicating a quality of service (QOS) flow definition, an evolved packet system (EPS) traffic flow definition, and a packet data protocol (PDP) context definition;
an MBS session ID field indicating the MBS session ID for Internet Protocol version 4 (IPv4) and Internet Protocol version 6 (IPv6) multicast addresses having a format that includes a source_IP_address and a destination_IP_address;
an MBS session ID type field populated with either a first value to indicate a temporary mobile group identity (TMGI), a second value to indicate a source specific IP multicast address for IPV4, or a third value to indicate a source specific IP multicast address for IPV6; or
an MBS operation field populated with either a first value to indicate joining the MBS PDU session or a second value to indicate leaving the MBS PDU session.
